(19) United States
(12) Patent Application Publication
(10) Pub. No.: US 2009/0256743 A1
(43) Pub. Date: Oct. 15, 2009

(54) Mobile positioning and tracking system

(75) Inventors: Kuan Yang Chen, Taipei City (TW); Yao Ming Yang, Taipei County (TW)

Correspondence Address: YH CHAN, 42 PIN OAKS DRIVE, PHOENIXVILLE, PA, 19460, US

(73) Assignees: Yao Ming Yang, Taipei County (TW); Kuan Yang Chen, Taipei City (TW); LIANZHUN TECHNOLOGY CORPORATION, Taipei County (TW)

(21) Appl. No.: 12/102,025

(22) Filed: Apr. 14, 2008

(51) Int. Cl. G01S 5/02

(52) U.S. Cl. 342/357.07; 342/450

(57) ABSTRACT

The present invention discloses a mobile positioning and tracking system that includes a master device and a slave device. Within a tracking range of the master device, a satellite is used for receiving a signal from the slave device, and then transmitting the signal to the master device to display an initial location of the slave device. Meanwhile, the master device compares the location of the master device with a relative direction, distance, height or angle of the location of the satellite signal received by the master device, such that the master device can search according to the relative location. If the slave device is situated within the tracking range of the master device, Zigbee is used for receiving a signal from the slave device to estimate the location of a target outside the tracking range, and accurately measure the relative location of the target within the tracking range.

### BACKGROUND OF THE INVENTION

The present invention relates to a tracking system, and more particularly to a mobile positioning and tracking system for positioning a target within a range of a tracking system by a global positioning technology, and tracking an actual location of the target within the range of the tracking system by a Zigbee technology.

As the research and development of communication technologies advance rapidly, traditional wireless transmission technologies including the infrared (IR) and radio frequency (RF) transmission technologies are replaced by the popular Bluetooth technology. At present, Zigbee and ultra wide band (UWB) are introduced to the wireless transmission market, and the Bluetooth, Zigbee and ultra wide band (UWB) technologies are adopted to create products and applications with low, mid and high transmission rates according to the characteristics of different technologies. For instance, Zigbee focuses on its low power consumption and transmission rate from 20 Kbps to 250 Kbps, and thus a product applying the Zigbee technology and using a general battery can maintain its normal operation for several months or years. Particularly, the Zigbee technology is used extensively in general portable electronic products, not just improving the cycle of using the electronic products, but also maintaining the basic wireless signal transmission function. Undoubtedly, it will be a big leap in technology, if the Zigbee technology and global positioning system (GPS) technology can be integrated into a positioning and tracking device, and such device can replace the traditional tracking devices and overcome the shortcomings of traditional tracking devices capable of tracking a target within a specific range only.

In view of the foregoing shortcomings, the inventor of the present invention based on years of experience in the related industry to conduct extensive researches and experiments, and finally developed a mobile positioning and tracking system that integrates Zigbee and global positioning system (GPS) with the positioning and tracking technology.

### BRIEF SUMMARY OF THE INVENTION

The primary objective of the present invention is to provide a mobile positioning and tracking system, applied to a standalone device for tracking moving objects outdoors without relying on a third-party communication channel, and displaying the location, direction, distance, height or angle of the target within a specific range by means of graphics or texts, while computing a relative location, relative direction, relative distance, relative height or relative angle between the positioning and tracking system and the target, and further displaying the information on a single screen.

Another objective of the present invention is to provide a mobile positioning and tracking system for positioning a target within a specific range of a tracking system by a global positioning technology, and tracking an actual location of the target within the range of the tracking system by a Zigbee technology, so as to reduce the tracking range and improve the accuracy greatly.

The mobile positioning and tracking system of the invention is characterized in that the positioning and tracking system comprises a master device and a slave device. If the master device is situated at a position beyond the tracking range, a satellite is used for receiving a signal from a slave device and transmitting the signal to a master device to display an initial location of the slave device. In the meantime, after the master device compares the location computed by the master device with a relative direction, relative distance, relative height or relative angle of the location of the signal received by the master device via the satellite, the master device searches the target according to the relative location. If the slave device is situated within the tracking range of the master device, the Zigbee technology is used for receiving a signal transmitted from the slave device, while the master device is comparing and calculating the location of the master device, and the relative direction, relative distance, relative height or relative angle with respect to the position where the master device receives the signal from the slave device to obtain the actual location of a target, so that the mobile position and tracking system of the invention can measure the location of the tracking target within the tracking range and precisely master the relative location of the tracking target within the tracking range.

In summation of the description above, the present invention comes with a simple structural design to achieve the expected effects. To make it easier for our examiner to understand the technical measures and performance of the invention, we use preferred embodiments accompanied with related drawings for the detailed description of the invention as follows.

### BRIEF DESCRIPTION OF THE DRAWINGS

FIG. 1 is a schematic view of a master device in accordance with a preferred embodiment of the present invention;

FIG. 2 is a schematic view of a slave device in accordance with a preferred embodiment of the present invention;

FIG. 3 is a schematic view of a way of using a positioning and tracking system in accordance with a preferred embodiment of the present invention; and

FIG. 4 is a schematic view of another way of using a positioning and tracking system in accordance with a preferred embodiment of the present invention.

### DETAILED DESCRIPTION OF THE INVENTION

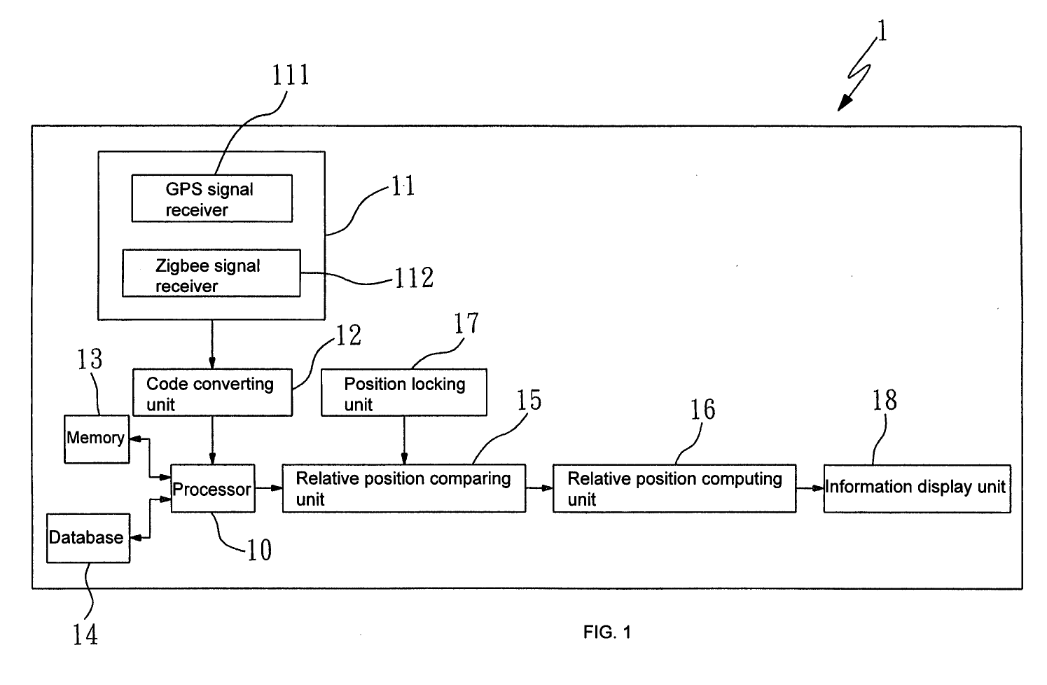

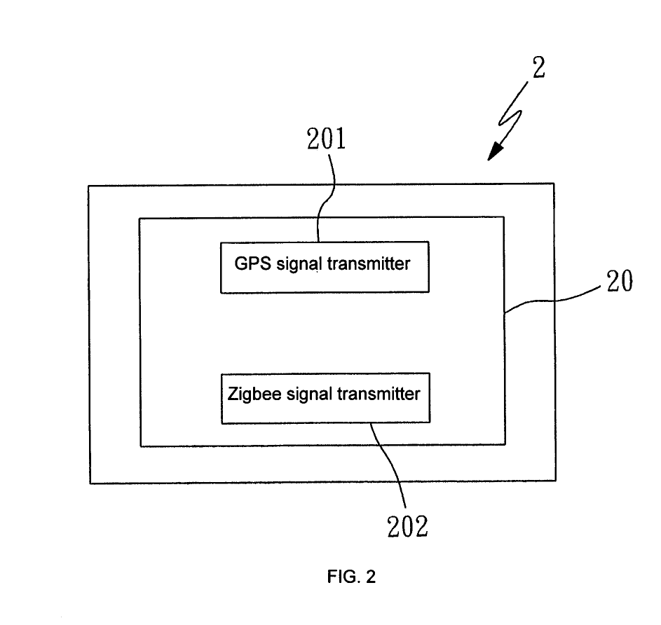

Referring to FIGS. 1 and 2 for schematic views of a mobile positioning and tracking system in accordance with a preferred embodiment of the present invention, the positioning and tracking system comprises a master device 1 and a slave device 2. In FIG. 1, the master device 1 comprises a processor 10, a signal receiving unit 11, a code converting unit 12, a memory 13, a database 14, a relative position comparing unit 15, a relative position computing unit 16, a position locking unit 17 and an information display unit 18. In FIG. 2, the slave device 2 includes a signal transmitting unit 20.

Further, the signal receiving unit 11 of the master device 1 further includes a GPS signal receiver 111 and a Zigbee signal receiver 112, and the signal transmitting unit 20 of the slave device 2 further includes a GPS signal transmitter 201 and a Zigbee signal transmitter 202.

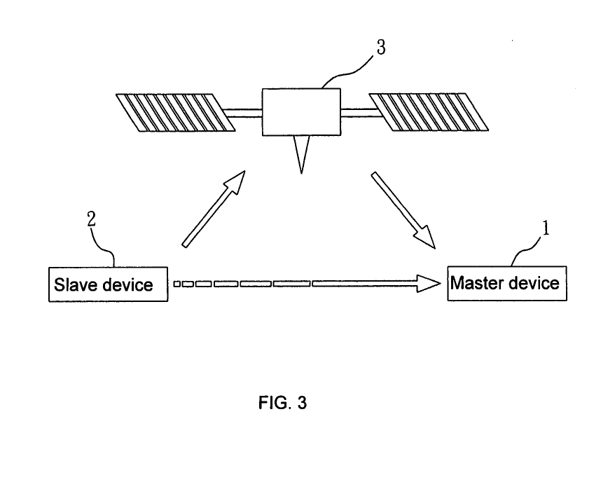

In a mobile positioning and tracking system as shown in FIGS. 1 to 3, the slave device 2 carried by or installed at a tracking target has a unique identification code for facilitating the identification of the device during the tracking process, and the slave device 2 provides an appropriate time interval for transmitting signals from a global positioning system (GPS) signal transmitter of the signal transmitting unit 20 to a remote satellite 3 and a Zigbee signal transmitter 202 synchronously. The master device 1 receives signals from the remote satellite 3 through the global positioning system (GPS) signal receiver 111 of the signal receiving unit 11 and the Zigbee signal receiver 112 synchronously, and the code converting unit 12 converts the location signal received by the signal receiving unit 11 into a location data and stores the location data into the memory 13, and the database 14 of the master device 1 prestores a logical coordinate data, and the processor 10 reads the logical coordinate data from the database 14 and the location data from the memory 13 to perform a floating point computation to compute the coordinate values of the location (and the coordinates include coordinate values of a 3D space, and the proportional position points on the display device are not the coordinates of the map information), and the position coordinates and the location data are compared by the relative location computing engine of the relative position comparing unit 15. After the data is compared, a relative location computing engine of the relative position computing unit 16 computes the data to obtain a single location, and the represented single location is displayed on a display device of the information display unit 18 in the form of graphics, texts, or numbers, and the display contents can be relative coordinate values (or 3D coordinate values) or information including relative distance, relative direction or relative height. Further, a position locking engine of the position locking unit 17 locks one previous single location or a plurality of single locations on the display device of the information display unit 18 to facilitate the search of a tracking single location or multiple of single locations.

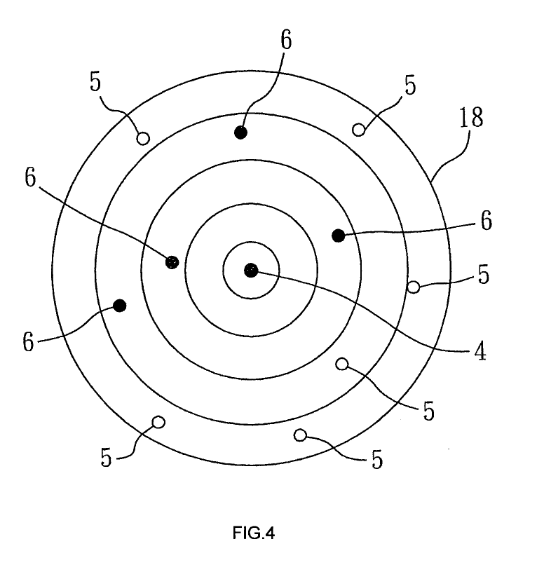

Referring to FIG. 4 as well as FIGS. 1 to 3 for schematic views of using a mobile positioning and tracking system in accordance with the present invention, when the master device 1 starts tracking, the global positioning system (GPS) signal receiver 111 of the signal receiving unit 11 receives a signal transmitted from the remote satellite 3, and the code converting unit 12 converts a location signal received by the signal receiving unit 11 from the satellite 3 into a location data and stores the location data into the memory 13, and the database 14 of the master device 1 prestores a logical coordinate data, and the processor 10 reads the location data from the logical coordinate data in the database 14 and the memory 13 to perform a floating point computation and compute the position coordinates, and the data of the position coordinates and the location data are compared by with the relative location comparing engine of the relative position comparing unit 15. After the data are compared, a relative location computing engine of the relative position computing unit 16 computes the data to obtain a single location, and the represented single location is displayed at a central position 4 on the screen of the display device of the information display unit 18. After completing the positioning, the master device 1 will start tracking the slave device 2. If the slave device 2 is situated within the tracking range of the Zigbee, the GPS signal transmitter 201 of the signal transmitting unit 20 will transmit a signal to the remote satellite 3, and the remote satellite 3 will transmit the signal to the master device 1, and the GPS signal receiver 111 of the signal receiving unit 11 of the master device 1 will transfer the signal received from the remote satellite 3 to the slave device 2. The code converting unit 12 converts the location signal received by the signal receiving unit 11 into a location data and stores the location data into the memory 13. The database 14 of the master device 1 prestores a logical coordinate data, and the processor 10 reads the logical coordinate data from the database 14 and the location data from the memory 13 to perform a floating point computation to compute the position coordinates. The data of the position coordinates and the location data are compared by the relative location comparing engine of the relative position comparing unit 15. After the data are compared, the relative location computing engine of the relative position computing unit 16 computes the data to obtain a single location, and the represented single location is displayed at an empty dot 5 away from the central position 4 of the screen of the display device of the information display unit 18, and each dot 5 represents each slave device 2. In the meantime, the independent identification code of the empty dot 5 and the information of the 3D relative coordinate value, relative distance, relative direction, or relative height are displayed on the display device of the information display unit 18. The master device 1 can approach the location of the slave device 2 with the empty dot 5 according to the information. If the empty dot 5 is moving, then the 3D relative coordinate value of the empty dot 5 or the information of relative distance, relative direction, relative height will be displayed on the display device of the information display unit 18, and the master device 1 will continuously receive and update the signals transferred from the remote satellite 3 to the slave device 2. If the empty dot 5 with the slave device 2 enters into the Zigbee tracking range of the master device 1, then the empty dot 5 will be changed to a real point 6, and the slave device 2 will transmit a signal from the Zigbee signal transmitter 202 of the signal transmitting unit 20 to the master device 1, and the Zigbee signal receiver 112 of the signal receiving unit 11 of the master device 1 will receive a signal from the slave device 2, and the code converting unit 12 will convert the location signal received by the signal receiving unit 11 into a location data and store the location data into the memory 13. The database 14 of the master device 1 prestores the logical coordinate data, and the processor 10 reads the logical coordinate data from the database 14 and the location data from the memory 13 to perform a floating point computation to compute the position coordinates, and the relative location comparing engine of the relative position comparing unit 15 compares the position coordinates and the location data. After the data are compared, the relative location computing engine of the relative position computing unit 16 computes the data to obtain a single location, and the represented single location displays a real point 6 at a position away from the central position 4 on the display device of the information display unit 18, and each real point 6 represents each slave device 2. In the meantime, the independent identification code and the 3D relative coordinate value of the real point 6 or the information of the relative distance, relative direction or relative height are displayed on the display device of the information display unit 18. The master device 1 can approach the location of the slave device 2 with the real point 6. If the real point 6 is moving, then the 3D relative coordinate value of the real point 6 and the information of the relative distance, relative direction or relative height are displayed on the display device of the information display unit 18, and then the master device 1 continuously receives and updates a signal of slave device 2 transferred from the remote satellite 3. Further a location locking engine of the position locking unit 17 locks one or more empty dots 5 or real points 6 on the display device of the information display unit 18 to facilitate the search of the locked target.

In addition to the computation of a relative location between the master device 1 and the slave device 2, the invention can also execute the computation of a relative location between two slave devices 2.

In summation of the description above, the mobile positioning and tracking system of the invention overcomes the shortcomings of the prior art, and complies with the requirements of patent application, and is thus duly filed for patent application.

While the technical contents and characteristics of the invention have been described by means of specific embodiments, numerous modifications and variations could be made thereto by those skilled in the art without departing from the scope and spirit of the invention set forth in the claims.

What is claimed is:

1. A mobile positioning and tracking system, comprising:
at least one master device, including a processor, a signal receiving unit, a code converting unit, a memory, a database, a relative position comparing unit, a relative position computing unit, a position locking unit and information display unit; and
at least one slave device, including a signal transmitting unit.

2. The mobile positioning and tracking system of claim 1, wherein the information display unit is a flat display device.

3. The mobile positioning and tracking system of claim 2, wherein the flat display device displays information of a relative distance, a relative direction or/and a relative height of the slave device with respect to the master device.

4. The mobile positioning and tracking system of claim 2, wherein the flat display device displays information of a relative distance, a relative direction or/and a relative height between the two master devices.

5. The mobile positioning and tracking system of claim 1, wherein the signal receiving unit of the master device is selectively a GPS signal receiver and a Zigbee signal receiver.

6. The mobile positioning and tracking system of claim 1, wherein the signal transmitting unit of the slave device is selectively a GPS signal transmitter and a Zigbee signal transmitter.

7. The mobile positioning and tracking system of claim 1, wherein the code converting unit converts a location signal received by the signal receiving unit into a location data.

8. The mobile positioning and tracking system of claim 7, wherein the location data is saved in the memory.

9. The mobile positioning and tracking system of claim 1, wherein the database prestores a logical coordinate data.

10. The mobile positioning and tracking system of claim 9, wherein the processor reads a logical coordinate data from the database and a location data from the memory for performing a floating point computation.

11. The mobile positioning and tracking system of claim 1, wherein the relative position comparing unit performs a relative location comparison with a location data obtained by the master device.

12. The mobile positioning and tracking system of claim 11, wherein the relative position computing unit computes a location compared by the master device to obtain a single location and display the single location on an information display unit.

13. The mobile positioning and tracking system of claim 1, wherein the position locking unit locks one or more slave devices displayed on the information display unit.
